(19) United States
(12) Patent Application Publication
(10) Pub. No.: US 2025/0204336 A1
(43) Pub. Date: Jun. 26, 2025

(54) AGRICULTURAL FOGGING MACHINE HAVING STEEL WIRE-INSERTED STRAIGHT PIPE STRUCTURE

(71) Applicant: BY S-TWO Co., Ltd., Seoul (KR)

(72) Inventor: Se Yol KIM, Seoul (KR)

(73) Assignee: BY S-TWO Co., Ltd., Seoul (KR)

(21) Appl. No.: 18/848,579

(22) PCT Filed: Mar. 24, 2023
(86) PCT No.: PCT/KR2023/003924

§ 371 Date: Sep. 19, 2024

(30) Foreign Application Priority Data
Mar. 30, 2022 (KR) 10-2022-0039846

(51) Int. Cl. A01G 13/06; A01M 7/00

(52) U.S. Cl. CPC A01G 13/06; A01M 7/0003

(57) ABSTRACT

An agricultural fogging machine having or operatively connected to a supply of a liquid chemical, having a transfer pump which transfers the liquid chemical through a flexible conduit and, by receiving a control signal from a control board, controls the flow of the liquid chemical through the conduit, and having a heater housing which controls the temperature of the liquid chemical received from the transfer pump. The control board is electrically connected to the transfer pump and the heater housing so as to transmit the control signal thereto, and a relay is electrically connected to the control board and changes an output signal according to a current transferred to an electromagnet installed therein. The heater housing has a heat exchanger operatively configured to control the temperature of the liquid chemical exiting the fogging machine through a spray tube, and the control board generates control signals by receiving Wi-Fi signals.

### TECHNICAL FIELD

The present disclosure relates to a fogging machine used for agricultural purposes, and relates to an agricultural fogging machine that increases heat exchange efficiency by amplifying the amount of vortex generation through a structure that inserts a steel wire having a predetermined diameter into a pipe.

BACKGROUND ART

An agricultural fogging machine is equipped with a heat exchange device that heats a liquid chemical with a heater and sprays the liquid chemical to the outside, and passes pesticides through a high-temperature heater to vaporize the fluid or maintain the pesticides in a high-temperature state in a form that is easy to spray.

The pipes inside the heater used in existing agricultural fogging machines use coil-shaped pipes to increase the heat exchange area and length. The coil-shaped pipes have problems such as the viscosity of pesticides and other chemicals increasing as they are heated, or impurities on the inner wall blocking the flow path and thus, causing frequent clogging.

Clogging of the pipes inside the heater of the agricultural fogging machine causes the entire heater to have to be replaced, and increases the cost of manufacturing and managing the agricultural fogging machine. In addition, frequent attachment and detachment of the heater of the agricultural fogging machine including electronic devices is pointed out as a factor that reduces the life of the agricultural fogging machine.

### DETAILED DESCRIPTION OF THE INVENTION

### Technical Problem

Against this background, according to one aspect of the present disclosure, a purpose thereof is to provide an agricultural fogging machine that reduces clogging by using a straight pipe instead of a coil-shaped pipe and makes cleaning easy in the event of clogging.

According to another aspect of the present disclosure, a purpose thereof is to provide an agricultural fogging machine that improves heat exchange efficiency by generating vortices by inserting a steel wire having a predetermined diameter into the pipe to solve the problem of difficulty in normal spraying due to a narrow heat exchange area, unlike the coil pipe type.

According to still another aspect of the present disclosure, a purpose thereof is to provide an agricultural fogging machine that adopts a plurality of pipes in a multi-stage configuration and forms patterns (for example, spiral diagonals, mesh-shaped nets, or the like) on inner and outer surfaces of the pipes to amplify the generation of a vortex effect.

According to still another aspect of the present disclosure, a purpose thereof is to provide a fogging machine that minimizes the use of chemicals by reducing a residence time of fluid passing through the pipe and is easy to transport with a small weight.

### Technical Solution

In order to achieve the above-described objects, according to a first embodiment, there is provided an agricultural fogging machine including: a liquid chemical storage container installed inside the fogging machine to supply a liquid chemical; a transfer pump configured to transfer the liquid chemical, stored in the liquid chemical storage container, through a conduit and control a flow rate of the liquid chemical; a heater housing configured to control a temperature of the liquid chemical received from the transfer pump through one or more heat exchanger inside the heater housing and control a temperature of the liquid chemical transferred to the outside of the fogging machine through a spray tube; and a steel wire inserted into a movement path of the liquid chemical in the heater housing to generate a vortex.

In the agricultural fogging machine, the heater housing may include a straight conduit for passing the liquid chemical. Moreover, the steel wire may be inserted into the straight conduit.

In the agricultural fogging machine, the steel wire may be inserted in a direction opposite to the movement path of the liquid chemical, and one end portion of the steel wire may be fixed. Moreover, the other end of the steel wire may be not fixed.

In the agricultural fogging machine, the movement path of the liquid chemical may be formed in an inner conduit of the heater housing and the steel wire may be inserted into the inner conduit. Moreover, a surface of the steel wire and an inner wall of the inner conduit may be patterned in a spiral shape having opposite directions.

In the agricultural fogging machine, the heater housing may include an inner pipe and an outer pipe, and the inner pipe and the outer pipe may separate the movement path of the liquid chemical.

In the agricultural fogging machine, the steel wire may include a plurality of grooves formed along a spiral pattern.

The agricultural fogging machine may further include a support structure configured to support the steel wire, and the support structure may further include an inner ring surrounding the steel wire and an outer ring attached to a surface of the spray tube.

In order to achieve the above-described objects, according to a second embodiment, there is provided an agricultural fogging machine configured to heat and spray a liquid chemical, the agricultural fogging machine including: a transfer pump configured to transfer the liquid chemical while controlling a flow rate of the liquid chemical; an internal conduit configured to pass the liquid chemical transferred from the transfer pump; a heater housing configured to control a temperature of the liquid chemical passing through the internal conduit and deliver the liquid chemical to the outside; and an insertion structure inserted into the inside of the internal conduit and configured to generate a vortex in a flow of the liquid chemical.

In the agricultural fogging machine, the inner conduit may be a straight pipe, and the insertion structure may be slidably inserted in a direction opposite to the liquid chemical movement path of the inner conduit and one end portion of the insertion structure may be fixed.

In the agricultural fogging machine, a surface of the inner conduit or the insertion structure may be patterned to generate friction with the liquid chemical.

### Effects of the Invention

As described above, according to the present disclosure, the problem of reducing the contact time with the inner wall of the heater tube due to the increase in the moving speed of the fluid when spraying the liquid chemical can be solved by inserting a steel wire by adopting the straight pipe structure.

According to the present disclosure, spraying efficiency of liquid chemical can be improved based on generation of vortex and increase effects in a residence time by the steel wire, and the agricultural fogging machine can be miniaturized by not using a large-capacity heater.

According to the present disclosure, by inserting the steel wire inside the heater pipe, heat exchange can occur at the inner wall of the heater tube due to the load and vibration applied when transporting the liquid chemical, heat exchange can also occur at the steel wire, the vortex phenomenon occurs along the steel wire during the transport of the liquid chemical, the contact surface between the liquid chemical and the inner wall of the heater tube significantly increases, and thus, the liquid chemical can be sprayed very efficiently.

### BRIEF DESCRIPTION OF THE DRAWINGS

FIG. 1 is a diagram explaining an operation process of an agricultural fogging machine that is operated in conjunction with a smartphone.

FIG. 2 is a block diagram for explaining an internal configuration of an agricultural fogging machine according to one embodiment.

FIG. 3 is a diagram for explaining a configuration of a heater housing inside the agricultural fogging machine according to one embodiment.

FIG. 4 is a diagram for explaining an operation control of a control board of the agricultural fogging machine according to one embodiment.

FIG. 5 is a first exemplary side view illustrating a side surface of the agricultural fogging machine according to one embodiment.

FIG. 6 is a top view illustrating an upper surface of the agricultural fogging machine according to one embodiment.

FIG. 7 is a second exemplary side view illustrating the side surface of an agricultural fogging machine according to one embodiment.

FIG. 8 is a third exemplary side view illustrating the side surface of the agricultural fogging machine according to one embodiment.

FIG. 9 is a diagram illustrating an agricultural fogging machine using a coil pipe type conduit.

FIG. 10 is an internal configuration diagram of an agricultural fogging machine having a steel wire-inserted straight pipe structure according to one embodiment.

FIG. 11 is an internal cross-sectional diagram of the agricultural fogging machine having a steel wire-inserted straight pipe structure according to one embodiment.

FIG. 12 is a diagram for explaining an internal pattern of a pipe according to one embodiment.

FIG. 13 is a diagram for explaining a surface pattern of a steel wire according to one embodiment.

FIG. 14 is a diagram for explaining a multi-stage pipe structure according to one embodiment.

FIG. 15 is an internal configuration diagram of an agricultural fogging machine having a steel wire-inserted straight pipe structure according to one embodiment.

### MODE FOR IMPLEMENTING THE INVENTION

Hereinafter, some embodiments of the present invention will be described in detail through exemplary drawings. When adding reference numerals to components in each drawing, it should be noted that the same components are given the same numerals as much as possible even if they are illustrated in different drawings. In addition, when describing the present invention, detailed descriptions of related known configurations or functions that may obscure the gist of the present invention are omitted.

In addition, when describing components of the present invention, terms such as first, second, a, b, or the like may be used. These terms are only intended to distinguish the components from other components, and the nature, order, or sequence of the components are not limited by the terms. When a component is described as being “connected”, “coupled”, or “joined” to another component, it should be understood that the component may be directly connected or connected to the other component, but another component may also be “connected”, “coupled”, or “joined” between each component.

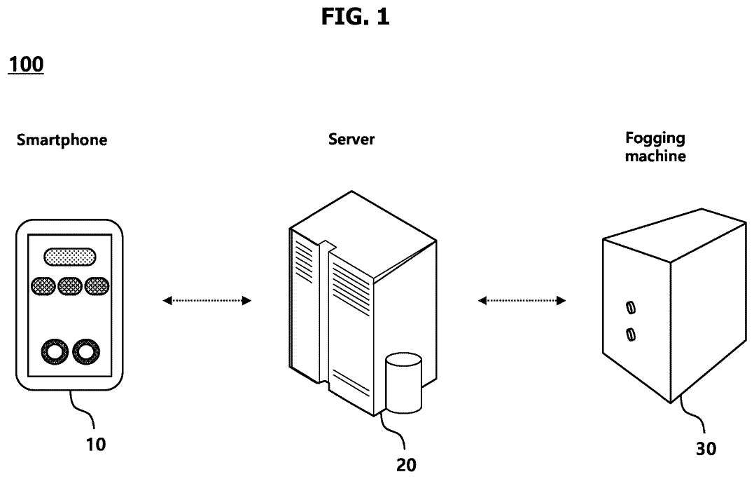

FIG. 1 is a drawing explaining an operation process of an agricultural fogging machine that is operated in conjunction with a smartphone.

Referring to FIG. 1, a fogging machine 30 may be operated in conjunction with a smartphone 10, a server 20, or the like.

Data generated through touch input of a smartphone 10 may be transferred to a server 20, and the server 20 may transfer a control signal to control the operation of the fogging machine 30 to the fogging machine 30.

The smartphone 10 is a device capable of running an application or a computer program, and may be any mobile device. For convenience of explanation, the term “smartphone” is used below, but the embodiments of the present specification are not limited thereto.

A screen of a mobile application running on the smartphone 10 may provide a user interface (UI) for controlling the power of the fogging machine 30, controlling components inside the heater housing, controlling the output of the transfer pump, or controlling the light emitting diode (LED) lighting.

The server 20 may mean an internal storage device installed in a computer device, but is not limited thereto and may include a cloud server, or the like.

The server 20 may receive and store a control signal generated by the touch input of the smartphone 10, and transmit the result of performing an appropriate operation through an internal algorithm to the control board stored inside the fogging machine 30.

The fogging machine 30 is a device for spraying liquid chemicals for pesticides and the like, and may include a liquid chemical storage container (not illustrated), a transfer pump (not illustrated), a heater housing (not illustrated), a control board (not illustrated), a relay (not illustrated), or the like.

The fogging machine 30 may be controlled remotely even when a user does not directly control the operation of the fogging machine 30 by receiving a wireless communication signal (for example, a Wi-Fi signal) transferred through a smartphone 10 and a server 20.

The operation of the fogging machine 30 may be divided into a step of applying power, a step of executing an application, a step of remotely controlling the fogging machine, or the like.

The steps of remotely controlling the fogging machine may include a step of operating a heater chamber to maintain the temperature of the fogging machine at a reference temperature, a step of operating the transfer pump, a step of performing the spraying of liquid chemicals, a step of operating the heater housing to perform heat exchange, and a step of restarting the transfer pump, and these repeated operations may be controlled differently according to the required number of set times.

For example, when the user inputs a one-touch signal, after the heater is operated for 330 seconds, the pump may be operated for 20 seconds. In succession, the heater may be operated for 80 seconds and the pump may be operated for 20 seconds, and the operations may be performed repeatedly and may be controlled by the mobile application.

For example, when the user inputs an emptying signal, the drain pump may be operated.

For example, when the user inputs a lighting signal, a timer function may be operated in a toggled manner.

For example, when a forced termination signal is input, a control board (for example, a microprocessor (MCU) board) may be reset.

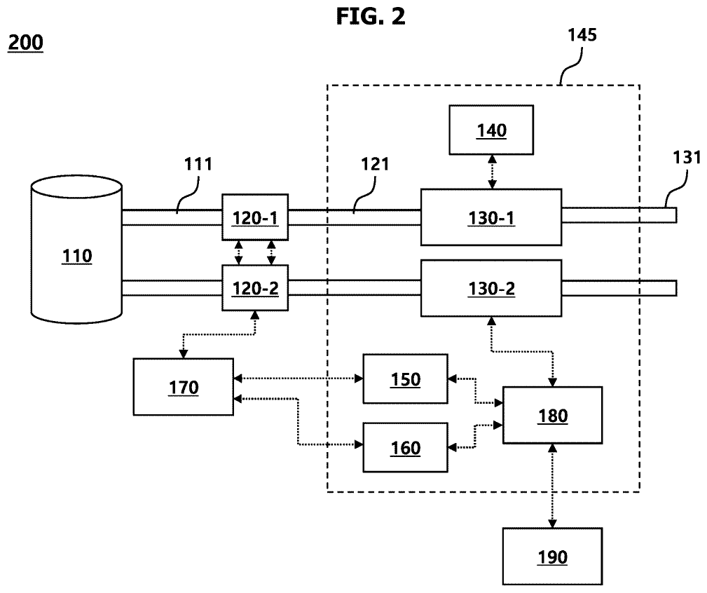

FIG. 2 is a block diagram for explaining an internal configuration of the agricultural fogging machine according to one embodiment.

Referring to FIG. 2, an agricultural fogging machine 200 may include a liquid chemical storage container 110, transfer pumps 120-1 and 120-2, heat exchangers 130-1 and 130-2, a buzzer 140, a temperature measuring device 150, a temperature fuse 160, a control board 170, a relay 180, a circuit breaker 190, or the like.

The agricultural fogging machine 200 may include a heater housing 145, and the heater housing 145 may be defined as including the heat exchangers 130-1 and 130-2, the buzzer 140, the temperature measuring device 150, the temperature fuse 160, the relay 180, or the like. In the following, the term such as the “heater housing” is used for convenience of explanation, but the present disclosure is not limited to this term, and other terms such as heater device may be used.

The liquid chemical storage container 110 may be installed inside the fogging machine and may be a space for storing liquid chemicals such as pesticides, and the size and shape of the liquid chemical storage container may be defined in various ways depending on the operating time of the fogging machine and the weight of the fogging machine. For example, the liquid chemical storage container 110 may be a cylindrical or rectangular storage container.

The transfer pumps 120-1 and 120-2 transfers the liquid chemical stored in the liquid chemical storage container through flexible conduits 111 and 121, and receives a control signal from the control board 170 to control the flow rate of the liquid chemical transferred to the heater housing 145 through the conduits 111 and 121.

When the flexible conduits 111 and 121 are used, the space inside the fogging machine 200 can be saved. For example, when the liquid chemical storage container 110 and the transfer pumps 120-1 and 120-2 are adjacent, or when the liquid chemical storage container 110, the transfer pumps 120-1 and 120-2, and the heat exchangers 130-1 and 130-2 are not located on a single straight line, space efficiency can be improved.

The pipe configuration inside the fogging machine, including the conduits 111 and 121, may be formed of metal such as copper, but is not limited thereto.

The configuration of the transfer pumps 120-1 and 120-2 may include, but is not limited to, a drive motor (not illustrated) for providing a drive force such as a rotational drive force, a pump piston (not illustrated) for controlling the flow rate in a cylinder shape, or the like.

The number of transfer pumps 120-1 and 120-2 may be defined differently depending on the number of heat exchangers and spray tubes. For example, when the number of spray tubes 131 is two, two transfer pumps may be formed.

For more efficient pump operation, a physical or electrical connection relationship may be formed between the transfer pumps 120-1 and 120-2.

The transfer pumps 120-1 and 120-2 may control the flow rate of the liquid chemical transferred to the conduit 121 or spray tube 131, and may change the flow rate of the liquid chemical according to the heat exchange efficiency of the heat exchangers 130-1 and 130-2 or the control signal of the control board 170.

The transfer pumps 120-1 and 120-2 may transfer the unheated liquid chemical to the heat exchangers 130-1 and 130-2.

The heat exchangers 130-1 and 130-2 may be connected to the conduit 121 to increase the temperature of the liquid chemical, and may have a form that surrounds the conduit 121 for orthogonal flow or counterflow.

The heat exchangers 130-1 and 130-2 may further include an inner conduit (not illustrated) passing through the conduit 121 and the spray tube 131, and may control the temperature of the liquid chemical passing through the inner conduit (not illustrated).

The spray tube 131 may spray the fluid transferred through the heat exchangers 130-1 and 130-2 through a spray nozzle (not illustrated), and may include a filter (not illustrated) to prevent the nozzle hole from being clogged, if necessary.

Since fine particles may be sprayed through the spray tube 131, improve the adhesive power of the agent, and control a spray amount as necessary, the use of the agent can be optimized by the spray tube 131.

The buzzer 140 may be a device that prevents external collision of the unmanned fogging machine 200 or generates an alarm for safety reasons. For example, the buzzer 140 may continuously generate an alarm during the operation time of the fogging machine 200.

The temperature measuring device 150 may be a device for measuring the temperature inside the heater housing 145 or measuring the temperatures of the heat exchangers 130-1 and 130-2.

The temperature measured by the temperature measuring device 150 may be transferred to the control board 170, and the control board 170 can generate a control signal such as cutting off the current of the temperature fuse 160 based on the temperature signal.

The temperature fuse 160 may mean a metal wire that melts and breaks before electrical components when a strong current flows, similar to a general fuse, and may directly react to the temperature inside the heater housing 145 or cut off the current according to the control signal of the control board 170.

The heater housing 145 may further include a temperature switch (not illustrated), and the temperature switch (not illustrated) may be connected to a control board 170 or a relay 180 to perform a switch function internally.

The control board 170 may be a micro controller unit (MCU) and may be a processor for controlling the operation of components inside the fogging machine 200 or performing calculations for such operations. If necessary, the circuit board may further include a memory (not illustrated) for data storage.

The control board 170 may control the operation of the heater housing 145 and may operate the heater housing 145 to preheat the heater housing. By performing a preheating process when the fogging machine 200 is initially heated, the operation efficiency of the fogging machine 200 may be improved.

The control board 170 may control the operations of the transfer pumps 120-1 and 120-2, and control the flow rate of the liquid chemical by operating the transfer pumps 120-1 and 120-2.

The control board 170 may control the operations of the heat exchangers 130-1 and 130-2, and control the temperature of the liquid chemical by operating the heat exchangers 130-1 and 130-2.

The control board 170 may generate a control signal to check and control the temperature or humidity inside the fogging machine 100, may generate a control signal regarding whether a ventilator (not illustrated) is operating and an operating output thereof, generate a control signal regarding whether a heater is operating and an operating output thereof, and generate a control signal for controlling the brightness of an LED light.

The relay 180 is electrically connected to the control board and may change the output signal according to the current transferred to the electromagnet installed inside. When the direction of the relay 180 is reversed so that the magnet part is located at the top, it can exhibit higher stability.

The circuit breaker 190 is configured to block an analog signal (for example, voltage or current) transferred from the outside as needed.

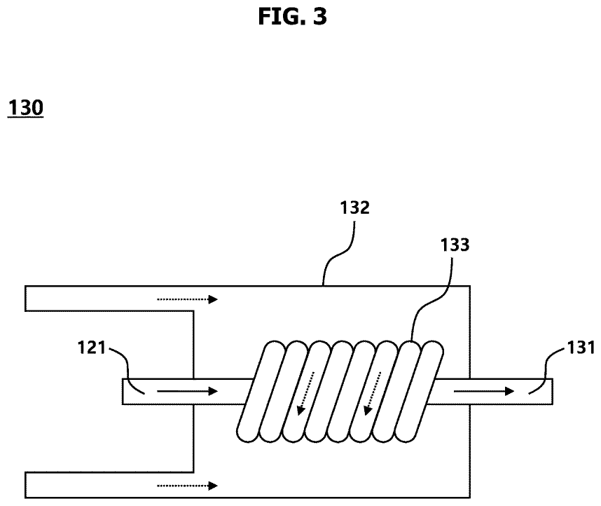

FIG. 3 is a drawing for explaining the configuration of the heater housing inside the agricultural fogging machine according to one embodiment.

Referring to FIG. 3, the heat exchanger 130 may include a fluid transfer unit 132, a heat exchange unit 133, or the like.

The heat exchanger 130 may transfer heat to the fluid transferred by the transfer pump (not illustrated) through the conduit 121 and discharge a high-temperature fluid through the spray tube 131.

The fluid transfer unit 132 may transfer heated fluid for heat exchange to the heat exchange unit 133, and the shape of the fluid transfer unit 132 may be designed in various ways.

The heat exchange unit 133 may increase the temperature of the fluid sprayed through the spray tube 131 by transferring high-temperature fluid adjacent to the conduit 121 and the spray tube 131, and the amount of temperature change may be changed in real time by receiving temperature data set by the control board 170.

The heat exchange unit 133, the conduit 121, and the spray tube 131 may adopt a coil-shaped pipe, but a straight-shaped pipe may be adopted. In the case where a straight-shaped pipe is used for the reason described below, a steel wire (not illustrated) may be inserted to amplify an amount of vortex generation, and the heat exchange time and heat exchange efficiency of the liquid chemical may be improved, thereby reducing the size of the heater housing.

When the heat exchanger 130 forms a liquid chemical movement path of a straight pipe structure, the transfer speed becomes fast when the liquid chemical is injected. As a result, the contact time and area between the heat exchanger 133 and the liquid chemical are small, the efficiency of the injection decreases, and thus, the structure of the general heat exchanger 130 is to solve the problem by using a large-capacity heater housing or increasing the movement path of the liquid chemical.

When a steel wire (not illustrated) is inserted into the heater pipe of the heat exchanger 130, heat exchange may occur not only in the inner wall of the heater tube but also in the steel wire due to the change (for example, the collision between the fluid and the steel wire) in the movement path of the fluid applied to the steel wire when the liquid chemical is transferred. When a steel wire (not illustrated) is inserted into the conduit inside the heat exchanger 130, a vortex phenomenon occurs in the flow of the liquid chemical along the steel wire while the liquid chemical is transferred, the contact time between the liquid chemical and the inner wall of the heater tube increases, and thus, the liquid chemical can be injected very efficiently. Due to this, highly efficient spraying is possible even with a small capacity heater housing, and the size of the heater housing can be reduced to miniaturize the agricultural fogging machine.

While the electricity available in most conventional greenhouses is less than 3 kW, spraying with a straight pipe-shaped sprayer requires a large heater of more than 6 kW, making it difficult to use in rural facilities. In comparison, when a steel wire is inserted into the straight pipe of the heater chamber of the same size, the spraying efficiency can be greatly improved even with a small heater of less than 2.5 kW, and the fogging machine can be operated without additional equipment in farms.

The heat exchanger in FIG. 3 is an example of a heat exchange method for controlling the temperature of the liquid chemical, and the technical idea of the present disclosure is not limited thereto.

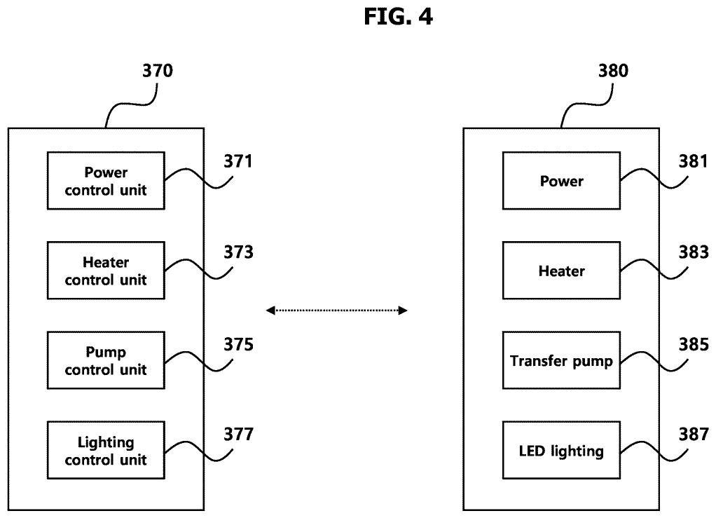

FIG. 4 is a diagram for explaining the operation control of the control board of the agricultural fogging machine according to one embodiment.

Referring to FIG. 4, a control board 370 may include a power control unit 371, a heater control unit 373, a pump control unit 375, a lighting control unit 377, or the like.

The power control unit 371 generates a signal for controlling power 381 inside the fogging machine 380, and may control output strength of the power 381 or change the power to an On or Off state.

The heater control unit 373 generates a signal for controlling a heater 383 inside the fogging machine 380, and may control the temperature inside the heater 383 or control the inflow of high-temperature fluid transferred to the inside of the heater, thereby changing the temperature condition inside the heater 383. The heater 383 may mean a heater housing (not illustrated), but may mean the internal configuration of the heater housing.

The pump control unit 375 generates a signal to control a transfer pump 385 inside the fogging machine 380, and can control the flow rate or hydraulic pressure of the fluid transferred through a conduit (not illustrated) by controlling the transfer pump 385.

The lighting control unit 377 generates a signal to control LED lighting 387 inside the fogging machine 380, and may change the amount of light emitted or the output intensity of each element by controlling the LED lighting 387.

The control board 370 may mean a power control unit 371, a heater control unit 373, a pump control unit 375, and a lighting control unit 377 as individual circuit configurations mounted within one control board 370, but may be configured as separate circuits.

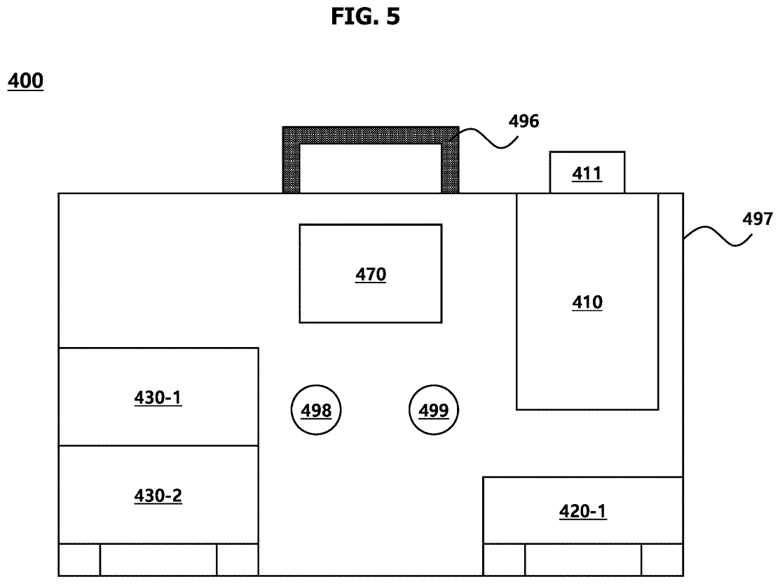

FIG. 5 is a first exemplary side view illustrating a side surface of an agricultural fogging machine according to one embodiment.

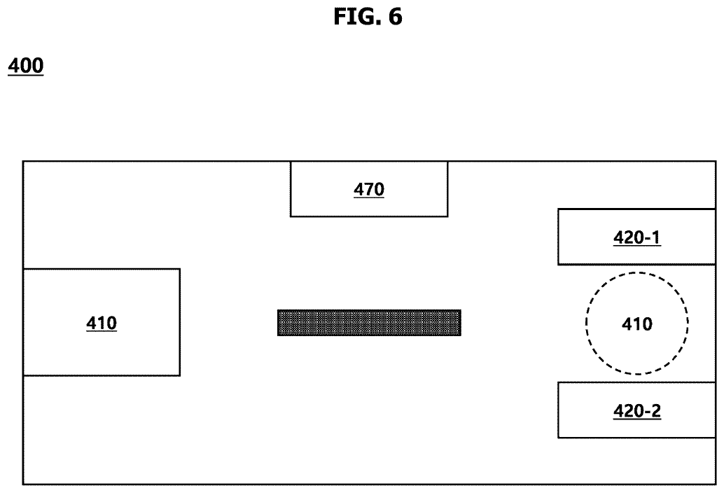

FIG. 6 is a top view illustrating an upper surface of an agricultural fogging machine according to one embodiment.

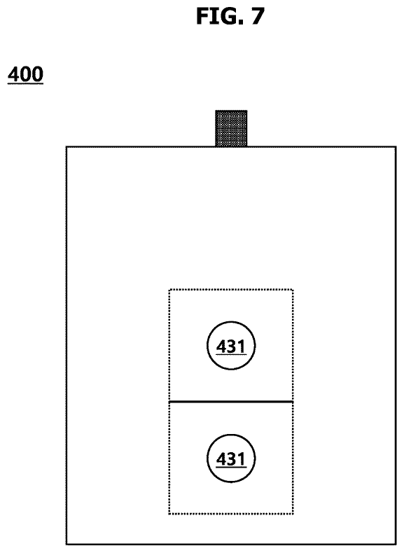

FIG. 7 is a second exemplary side view illustrating the side surface of the agricultural fogging machine according to one embodiment.

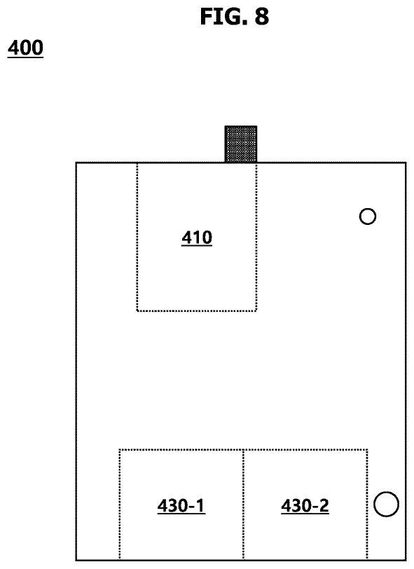

FIG. 8 is a third exemplary side view illustrating the side surface of the agricultural fogging machine according to one embodiment.

Referring to FIGS. 5 to 8, the agricultural fogging machine 400 may include a liquid chemical storage container 410, a liquid chemical stopper 411, a first transfer pump 420-1, a second transfer pump 420-2, a first heat exchanger 430-1, a second heat exchanger 430-2, a spray tube 431, a control board 470, a handle 496, a frame 497, an exhaust fan 498, an intake fan 499, or the like.

The agricultural fogging machine 400 according to one embodiment may have a more stable structure and generate high spraying efficiency through the arrangement as illustrated in FIGS. 5 to 8.

The liquid chemical storage container 410 may be fixed to the upper end of the frame so that the liquid chemical can be injected into the frame, and the liquid chemical may be prevented from being exposed to the outside air through the liquid chemical stopper 411.

The liquid chemical stopper 411 may be opened only when the liquid chemical is injected.

The first transfer pump 420-1 and the second transfer pump 420-2 may be installed spaced apart from each other at the lower end of the liquid chemical storage container 410, and be fixed to the lower end of the frame.

The first transfer pump 420-1 and the second transfer pump 420-2 may be installed around the liquid chemical storage container 410.

The first transfer pump 420-1 and the second transfer pump 420-2 may be the aforementioned transfer pumps, and may be arranged to increase spatial efficiency since they may transfer liquid chemicals by a flexible pipe.

The first transfer pump 420-1 and the second transfer pump 420-2 may be installed at a certain distance from the floor to improve durability, and may be fixed to one side of the frame.

The first heat exchanger 430-1 and the second heat exchanger 430-2 may be installed on a side opposite to one side surface where the transfer pump is installed, and may form an outlet to protrude the spray tube 431 outside the fogging machine.

The first heat exchanger 430-1 and the second heat exchanger 430-2 may be individually connected to each of the plurality of spray tubes 431.

The spray tube 431 may be installed on one side surface of the frame 497 and formed by welding after cutting.

The spray tube 431 may be connected to the outside of the fogging machine through a hole formed in the frame 497.

The control board 470 can perform the function of the aforementioned control board and can be installed in the center of the fogging machine 400 to improve durability and prevent durability reduction caused by vibration.

The control board 470 may be attached to one side surface of the frame 497.

The handle 496 may be installed at an uppermost end portion of the fogging machine 400 and be used to move the fogging machine 400.

The frame 497 may separate the external environment of the fogging machine 400 and the internal components, and generate a physical isolation or thermal isolation effect. The shape of the frame 497 may have a rectangular parallelepiped shape, but is not limited thereto.

The exhaust fan 498 may form a fan so as to discharge air inside the fogging machine 400.

The intake fan 499 may form a fan so as to introduce air outside the fogging machine 400.

FIGS. 5 to 8 are provided to illustrate the structure of the agricultural fogging machine according to the present disclosure, and the technical idea of the present disclosure is not limited thereto.

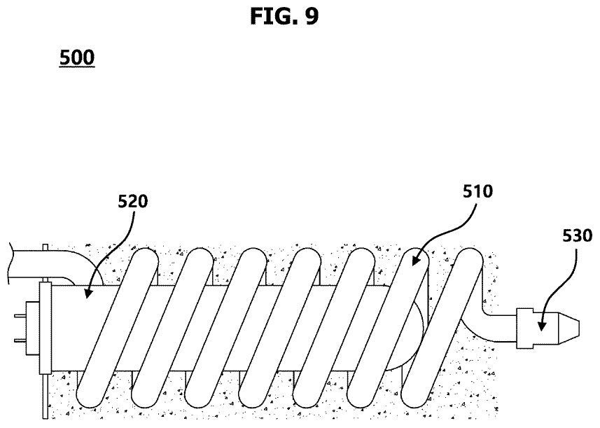

FIG. 9 is a drawing illustrating an agricultural fogging machine using a coil pipe type conduit.

Referring to FIG. 9, the agricultural fogging machine 500 may include an inner conduit 510, a heat exchanger 520, a spray tube 530, or the like.

The inner conduit 510 may receive heat energy from the heat exchanger 520 and control the temperature of a fluid (for example, a liquid chemical) to transfer the fluid to the spray tube 530.

The conventional inner conduit 510 uses a coil pipe type conduit, which causes frequent clogging, resulting in the problem of having to replace the entire heater housing. This results in a realistic limitation that increases the cost and the difficulty of after-sales service (A/S).

The coil pipe type conduit 510 increases the residence time of the fluid to improve the heat exchange efficiency, thereby increasing the effective heat exchange time, but when the passing fluid is a mixture, there is a problem that a clogging phenomenon occurs due to internal sedimentation or precipitation.

When a straight pipe type conduit is used to improve the clogging phenomenon of the inner conduit 510, the clogging phenomenon can be reduced, but the heat exchange area and time are reduced, so there is a problem that heat exchange cannot be performed up to the required temperature. In particular, in the straight pipe structure, the movement speed of the liquid chemical spray increases, and in order to improve the heat exchange efficiency, the length of the conduit should be increased by utilizing a large-capacity heater housing. As a result, the size of the agricultural fogging machine increases, and as a result, the portability of the agricultural fogging machine is drastically reduced.

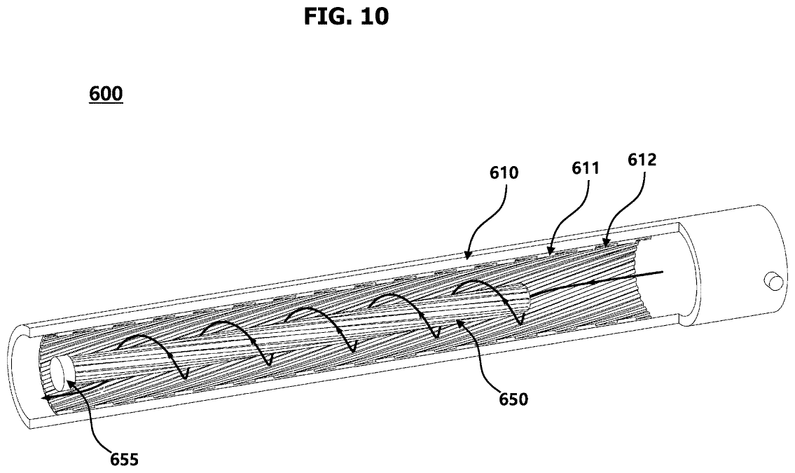

FIG. 10 is an internal configuration diagram of an agricultural fogging machine having a steel wire-inserted straight pipe structure according to one embodiment.

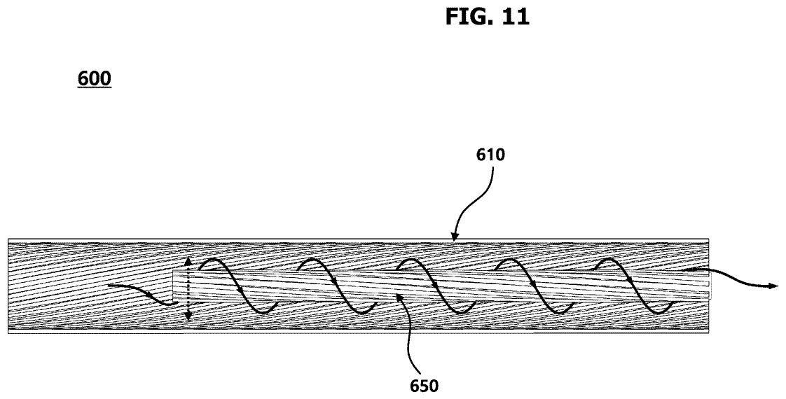

FIG. 11 is an internal cross-sectional view of the agricultural fogging machine having a steel wire-inserted straight pipe structure according to one embodiment.

Referring to FIGS. 10 and 11, an agricultural fogging machine 600 according to the present disclosure may include an inner conduit 610, a steel wire 650, or the like.

The agricultural fogging machine 600 may further include a liquid chemical storage container (not illustrated) installed inside the fogging machine to supply a liquid chemical, a transfer pump (not illustrated) that transfers the liquid chemical stored in the liquid chemical storage container through a flexible conduit and controls the flow rate of the liquid chemicals, and a heater housing (not illustrated) that controls the temperature of the liquid chemical transferred from the transfer pump through one or more heat exchangers installed inside and controls the temperature of the liquid chemical transferred to the outside of the fogging machine through a spray tube.

The inner conduit 610 may be formed inside the heater housing (not illustrated) and may be a conduit that passes liquid chemicals.

The inner conduit 610 can reduce clogging by utilizing a straight pipe structure, and can be easily cleaned when clogging occurs. By inserting a steel wire 650 into a fluid movement path (for example, the center of the conduit) of the inner conduit 610 to increase the residence time of the fluid and thereby increase the heat exchange time, this disadvantage can be compensated for.

The inner conduit 610 can include a plurality of protrusions 611 and grooves 612, and thus the surface can be patterned, but the patterning of the inner conduit 610 can be omitted if necessary.

The steel wire 650 may be inserted into the heater housing (not illustrated) to generate a vortex and change the movement path of the fluid, and may be a structure that can be inserted into the inner conduit 610. The steel wire 650 may be formed of a material such as steel, but any metal material may be adopted for the steel wire.

The steel wire 650 may be inserted in a direction opposite to the movement path (movement direction) of the liquid chemical, and one end portion of the steel wire may be fixed. The steel wire 650 may be maintained in a state where one end portion thereof is fixed and the other end portion thereof is not fixed. The non-fixed end portion of the steel wire 650 may generate vibration due to the flow of the fluid, may amplify the generation of a vortex, and may improve the heat exchange efficiency by generating a mixing effect of the fluid. The non-fixed end portion of the steel wire 650 may play a role in exchanging the fluid in which heat exchange has occurred on the surface of the inner conduit 610 with the fluid in which heat exchange has not occurred.

Since the steel wire 650 is inserted in the direction opposite to the movement path of the liquid chemical, it is possible to increase the convenience of the user and control the degree of insertion of the steel wire 650. The fixed one end portion of the steel wire 650 may be fixed by a support structure 655 such as a screw, and may be fixed by being coupled by the surface friction of the inner conduit 610. The steel wire 650 may be defined as an insertion structure, or the like as needed.

The steel wire 650 may be a cylindrical structure having a constant diameter, but may be designed to be formed as a structure having a tapering shape such as a cone to generate flexible movement inside the inner conduit 610 and have a coupling force at the distal end thereof, and may have various modified embodiments that are not limited thereto. The length and thickness of the steel wire 650 may be a size defined by calculating the target heat exchange efficiency of the internal liquid chemical in advance and may be defined by the resonance frequency of the fluid, but the present disclosure can adopt various measurement criteria that are not limited thereto.

The surface of the steel wire 650 and the inner wall (for example, the inner wall of the inner conduit 610) of the heater housing may be patterned in a spiral shape having opposite directions. For example, the surface of the steel wire 650 may have a clockwise spiral pattern, and the inner wall of the inner conduit 610 may have a counterclockwise spiral pattern. The surface patterning of the steel wire 650 and the inner conduit 610 is intended to increase the internal vortex effect and improve heat exchange efficiency, and may be variously defined according to the diameters of the steel wire and the conduit, and each surface patterning may be performed independently and selectively.

The surface patterning of the steel wire 650 and the inner conduit 610 may be adopted for vortex amplification, but may be implemented in an omitted form as needed.

The flow of liquid chemical illustrated in FIG. 10 and FIG. 11 is for exemplifying the vortex generated by the spiral shape patterning of the steel wire, and the flow of liquid chemical inside the agricultural fogging machine is not limited thereto.

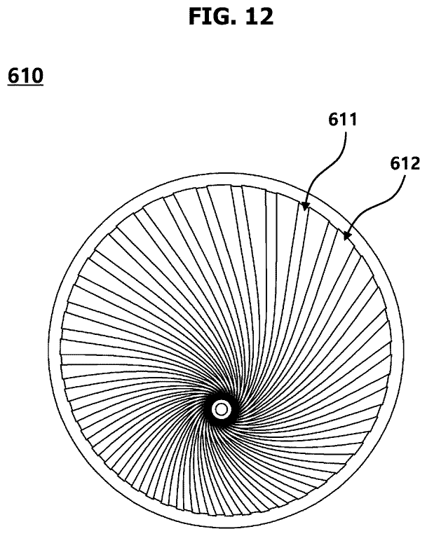

FIG. 12 is a drawing for explaining the internal pattern of a pipe according to one embodiment.

Referring to FIG. 12, the inner conduit 610 may include a plurality of protrusions 611 and grooves 612 on the inside or outside of the surface to form a certain pattern.

In the case where the agricultural fogging machine uses one inner conduit 610, the protrusions 611 and grooves 612 inside may be implemented in a screw-like twisted shape to form a spiral shape patterning, but is not limited thereto.

When the agricultural fogging machine uses a plurality of inner conduits 610, the protrusions 611 and grooves 612 may be implemented in a screw-like shape inside or outside to form a spiral shape patterning, but are not limited thereto.

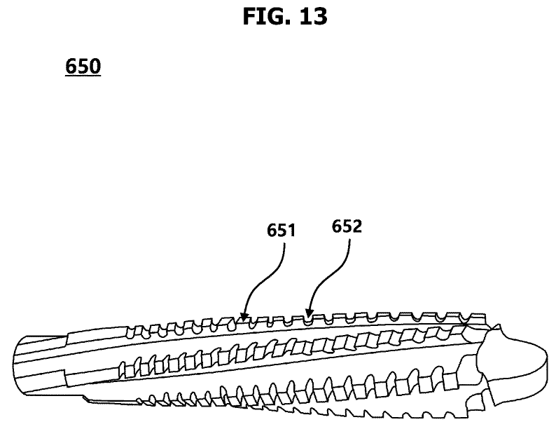

FIG. 13 is a drawing for explaining a surface pattern of a steel wire according to one embodiment.

Referring to FIG. 13, the steel wire 650 may form a certain pattern by including a plurality of protrusions 651 and grooves 652 on the surface.

The plurality of protrusions 651 and grooves 652 may be formed along the spiral pattern formed on the steel wire 650, and each protrusion 651 and groove 652 may have the same or different size and shape. If necessary, the steel wire 650 may be configured to have various sizes and shapes of protrusions 651 and grooves 652 to form a random pattern, but is not limited thereto.

The steel wire 650 may primarily form a pattern through N main lines (N is a natural number greater than or equal to 2), and secondarily form a pattern through protrusions 651 and grooves 652, thereby improving friction and heat exchange of the fluid. The protrusions 651 and grooves 652 have a hook shape in the direction opposite to the flow direction of the fluid, thereby increasing frictional force, thereby increasing the residence time of the fluid, and improving the mixing rate.

The steel wire 650 may include the plurality of protrusions 651 and grooves 652 to amplify vortex generation, but may have a smooth surface that does not perform separate patterning.

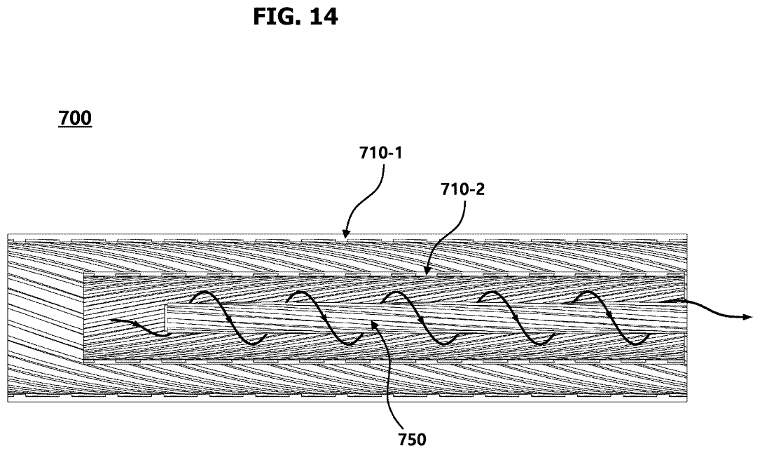

FIG. 14 is a drawing for explaining a multi-stage pipe structure according to one embodiment.

Referring to FIG. 14, an agricultural fogging machine 700 may include a plurality of pipes, and may include an outer pipe 710-1, an inner pipe 710-2, a steel wire 750, or the like.

The outer pipe 710-1 and the inner pipe 710-2 may separate the movement path of the liquid chemical, and thus, a spray angle and spray speed of a first liquid chemical movement path formed between the outer pipe 710-1 and the inner pipe 710-2 and a second liquid chemical movement path formed between the inner pipe 710-2 and the steel wire 750 may be controlled. By controlling cross-sectional areas and diameters of the outer pipe 710-1, inner pipe 710-2, and steel wire 750, an injection amount and distance of the liquid chemical may be appropriately controlled, and this calculation may be performed by considering Bernoulli's principle, or the like.

The outer pipe 710-1, inner pipe 710-2, and steel wire 750 may effectively perform a vortex effect by performing patterning on the surface, and the lengths of the inner pipe 710-2 and steel wire 750 may be controlled differently to change the movement path of the fluid inside.

The inner pipe 710-2 can perform spiral shape patterning, and can form holes such as mesh shapes as needed to mix the movement path of the fluid.

The steel wire 750 may generate a vortex in the movement path of the inner pipe 710-2 or in the movement path of the outer pipe 710-1.

By inserting the steel wire into a multi-pipe such as the outer pipe 710-1, the inner pipe 710-2, and the steel wire 750, the vortex generation effect of the internal fluid can be maximized.

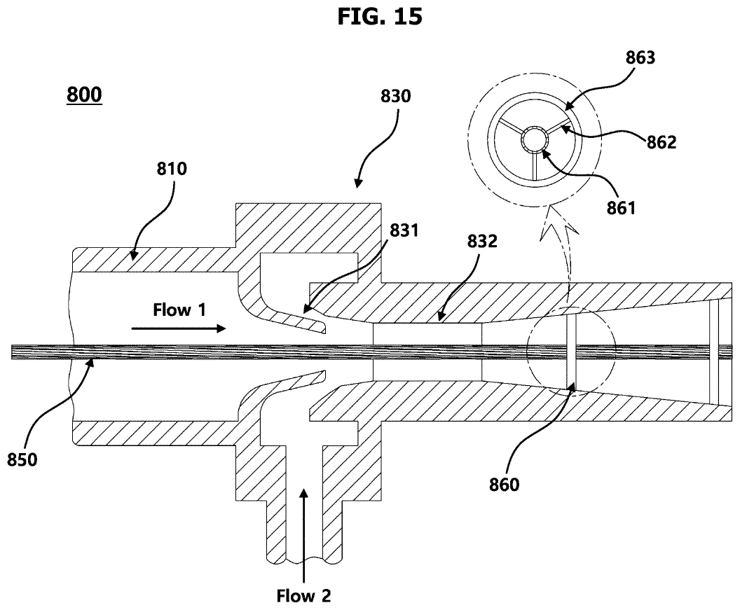

FIG. 15 is an internal configuration diagram of an agricultural fogging machine having a steel wire-inserted straight pipe structure according to one embodiment.

Referring to FIG. 15, an agricultural fogging machine 800 may include an inner conduit 810, a spray tube 830, a steel wire 850, a support structure 860, or the like.

The agricultural fogging machine 800 may further include a transfer pump (not illustrated) that controls the flow rate of liquid chemical and transfers the liquid chemical, a heater housing (not illustrated) that passes liquid chemical transferred from the transfer pump and controls the temperature of the liquid chemical and transfers the liquid chemical to the outside, or the like.

The inner conduit 810 may be a conduit that receives liquid chemical from the transfer pump (not illustrated), and may be implemented as a separate or integral type with respect to the spray tube 830. The inner conduit 810 may be a straight pipe, and the surface of the inner conduit 810 may form a certain pattern, but is not limited thereto.

The spray tube 830 may optionally include a nozzle 831 or a diffuser 832, and each configuration may be omitted as needed. The spray tube 830 may mix a liquid chemical having a first flow with air having a second flow and discharge the mixture to the outside, and various configurations may be omitted or included depending on the purpose of the fluid injection.

The steel wire 850 may be a structure that is included in the center of the fluid movement path such as the inner conduit 810, the spray tube 830, or the like to reduce the spray cross-sectional area of the fluid and generate a vortex inside. The steel wire 850 may be inserted into the conduit to perform free movement, but one end portion may be maintained in a fixed state by a support structure 860, or the like and the other end portion may be maintained to perform free movement. The steel wire 850 may be combined by slidingly inserting in the direction opposite to the fluid movement path of the inner conduit 810. The steel wire 850 may be defined as an insertion structure as a structure that is inserted from the outside and coupled.

When the support structure 860 may restrict the movement of the steel wire 850, a form such as a tightening screw may be adopted, but in order not to restrict the flow of the fluid, the support structure may be a form including a plurality of rings.

The support structure 860 is a structure attached to the surface of the steel wire 850 to support the steel wire, and may include an inner ring 861 surrounding the steel wire, an outer ring 863 attached to the surface of the spray tube, a ring joint 862, or the like.

In the support structure 860, the number of ring joints 862 or thicknesses of the inner ring 861 and the outer ring 863 may vary in consideration of the flow of the fluid. The inner ring 861 may be a flexible ring that is attached and detached to the surface of the steel wire, and the outer ring 863 may be a flexible ring that is press-fitted and joined to the inner surface of the spray tube 830, but is not limited thereto.

The support structure 860 may be placed only at the end where the fluid is sprayed in order to increase the shaking effect of the steel wire 850, and a plurality of support structures may be manufactured in the same or different sizes in order to increase the convenience of the user according to the press-fit.

FIG. 15 is a diagram for explaining the structure of an agricultural fogging machine into which a steel wire is inserted, and the internal structure of the agricultural fogging machine and the flow of the liquid chemical are not limited thereto.

What is claimed is:

1. An agricultural fogging machine comprising:
a liquid chemical storage container installed inside the fogging machine to supply a liquid chemical;
a transfer pump configured to transfer the liquid chemical, stored in the liquid chemical storage container, through a conduit and control a flow rate of the liquid chemical;
a heater housing configured to control a temperature of the liquid chemical received from the transfer pump through one or more heat exchanger inside the heater housing and control a temperature of the liquid chemical transferred to the outside of the fogging machine through a spray tube; and
a steel wire inserted into a movement path of the liquid chemical in the heater housing to generate a vortex.

2. The agricultural fogging machine of claim 1, wherein the heater housing includes a straight conduit for passing the liquid chemical, and the steel wire is inserted into the straight conduit.

3. The agricultural fogging machine of claim 1, wherein the steel wire is inserted in a direction opposite to the movement path of the liquid chemical, one end portion of the steel wire is fixed, and the other end of the steel wire is not fixed.

4. The agricultural fogging machine of claim 1, wherein the movement path of the liquid chemical is formed in an inner conduit of the heater housing, the steel wire is inserted into the inner conduit, and a surface of the steel wire and an inner wall of the inner conduit are patterned in a spiral shape having opposite directions.

5. The agricultural fogging machine of claim 1, wherein the heater housing includes an inner pipe and an outer pipe, and the inner pipe and the outer pipe separate the movement path of the liquid chemical.

6. The agricultural fogging machine of claim 1, wherein the steel wire includes a plurality of grooves formed along a spiral pattern.

7. The agricultural fogging machine of claim 1, further comprising a support structure configured to support the steel wire, wherein the support structure further includes an inner ring surrounding the steel wire and an outer ring attached to a surface of the spray tube.

8. An agricultural fogging machine configured to heat and spray a liquid chemical, the agricultural fogging machine comprising:
a transfer pump configured to transfer the liquid chemical while controlling a flow rate of the liquid chemical;
an internal conduit configured to pass the liquid chemical transferred from the transfer pump;
a heater housing configured to control a temperature of the liquid chemical passing through the internal conduit and deliver the liquid chemical to the outside; and
an insertion structure inserted into the inside of the internal conduit and configured to generate a vortex in a flow of the liquid chemical.

9. The agricultural fogging machine of claim 8, wherein the inner conduit is a straight pipe, and the insertion structure is slidably inserted in a direction opposite to the liquid chemical movement path of the inner conduit and one end portion of the insertion structure is fixed.

10. The agricultural fogging machine of claim 8, wherein a surface of the inner conduit or the insertion structure is patterned to generate friction with the liquid chemical.
